(19) United States
(12) Patent Application Publication
(10) Pub. No.: US 2003/0025086 A1
(43) Pub. Date: Feb. 6, 2003

(54) Device for the detecting of aflatoxins

(76) Inventor: Jorg Stroka, Duisburg (DE)

Correspondence Address: NATH & ASSOCIATES, PLLC, Sixth Floor, 1030 15th Street, N.W., Washington, DC, 20005, US

(21) Appl. No.: 10/245,758

(22) Filed: Sep. 18, 2002

Related U.S. Application Data
(63) Continuation of application No. PCT/EP01/02125, filed on Feb. 26, 2001.

(30) Foreign Application Priority Data
Apr. 14, 2000 (LU) 90 565

(51) Int. Cl. G01N 21/64

(52) U.S. Cl. 250/461.1; 356/417

(57) ABSTRACT

A compact and portable analytical instrument dedicated to aflatoxin determination under minimum electrical power conditions employs a light emitting diode (LED) as light source with a peak output wavelength of 370 nm in addition to a 418 nm cut-off filter and a photodiode with a peak sensitivity of 140 nm. Thus, the relative amount of transmitted fluorescence energy at a wavelength of greater than 418 nm incident upon the aflatoxin is separated from the excitation light of 370 nm. In addition to the LED and the photodiode, the instrument preferably comprises amplifying, digital conversion, data storage, data transfer, display and power supply means and a graphical data output. The power supply regulator is a integrated circuit. As a result, current consumption is minimised, and thus battery life and instrument accuracy is maximised. The LED is powered by a constant current regulator, which minimises errors due to fluctuations in illumination intensity.

### Introduction

The present invention relates to a device for the detection of aflatoxins, especially for the quantification of aflatoxins on a thin layer chromatogram (TLC). Aflatoxin determination is recognised as one of the most crucial parameters in food control, particularly for the detection of aflatoxin B1. Such measurements are today generally carried out by the use of high-pressure liquid chromatography (HPLC). However in those cases where HPLC equipment is not available or appropriate, the determination by thin layer chromatography (TLC) is commonly used. Commercial TLC scanners are available for the purpose of aflatoxin determination after TLC separation of the aflatoxins. These commercially available products TLC scanners use mercury lamps with an emission wave-length of 366 nm as a light source, while the detector consists of photo-multiers. It is clear that due to the high power consumption of these components, these scanners are unsuitable for use where no constant electrical power is available. Furthermore these TLC scanners are quite unwieldy and therefore not suitable for in-field analysis.

### OBJECT OF THE INVENTION

The object of the present invention is to provide a compact device for the detection of aflatoxins, which is well suited for in-field analysis.

### GENERAL DESCRIPTION OF THE INVENTION

In order to overcome the abovementioned problems, the present invention proposes a device for the detection of aflatoxin, comprising a sample holder, an excitation unit and a detection unit, wherein said excitation unit comprises an light emitting diode, said light emitting diode for emitting an excitation radiation having an excitation wavelength in the ultraviolet spectrum, wherein said detection unit comprises a cut-off filter and a photodiode, said cut-off filter having a cut-off wavelength which is higher than said excitation wavelength of said light emitting diode and said photodiode having a sensitivity at a sensing wavelength which is higher than said cut-off wavelength, and wherein said sample holder, said excitation unit and said detection unit are arranged so that said excitation radiation is emitted towards a sample placed in said sample holder and that said cut-off filter and said photodiode are positioned in the direction of emission of a fluorescence radiation emitted from said sample.

The aflatoxin detection device of the present invention uses the fact, that radiant energy of a certain wavelength can produce fluorescence in a certain substance with an allocated pi-electron system. The wavelength of the emitted light is significantly different (longer) than the excitation wavelength. Typically, the emitted amount of light is then equivalent to the amount of the substance, if the excitation is constant.

A device for the determination of aflatoxin according to the invention is designed to operate with simple means at suitable wavelengths for light emission, fluorescence detection and with a cut-off filter with an appropriate cut-off wavelength. The active elements of the detection cell, e.g. light emitting diode and photodiode, comprise only solid state devices. Thus the power consumption of this device is significantly lower than that of other known fluorescence measuring devices. Hence it is possible to operate this device with a battery as power supply, rendering the device independent from constant electrical power.

Further to the low power consumption, the device according to the present invention is characterised by very small dimensions. In fact the use of semiconductor devices instead of mercury lamps and photo multipliers allows to minimise the dimensions of the detector cell. It follows that the proposed device is a compact and portable device, being very suitable for in-field analysis.

In addition, the low costs of the semiconductor parts and the long lifetime of ultraviolet light emission electrodes result in an inexpensive, reliable and maintenance free device.

In a preferred embodiment, the light emitting diode, said cut-off filter and sad photodiode are chosen so that said excitation radiation has a peak wavelength of about 370 nm, said cut-off wavelength is about 418 nm and said photodiode has a sensitivity peak at a sensing wavelength of about 440 nm.

Said excitation unit and said detection unit are preferably arranged in a shielded housing, said shielded housing comprising an window transparent to ultraviolet radiation. In this case the said sample holder is arranged so that a sample placed in said sample holder is positioned outside of said shielded housing in front of said window. The shielded housing can e.g. comprise a discrete metal container hosting the UV-LED, the photodiode and the cut-off filter. This shielded housing can effectively protect the detection cell against any influence by scattered light as well as by electrostatic or magnetic fields. The optical window, e.g. a slit, preferably covers a bandwidth of approximately 1.2 to 2 times the diameter of the aflatoxin spots on the TLC plates (typically 1 cm) and has a slit width of approximately 1 to 2 mm. The optical window might be covered with an exchangeable, non self-fluorescent and UV-transparent plate to protect the detector cell.

The distance between the optical window and the photo diode (with its cut-off filter) is advantageously designed to be as short as possible and is limited to the dimensions of the photo-diode (a typical distance is 1 cm). The distance between the LED and the optical window is as short as possible, while still larger than that distance between the photo diode and the optical window.

The inner walls of said shielded housing comprise preferably a coating for absorbing radiation with a wavelength comparable to said excitation wave-length. This coating could comprise an UV light absorbing paint for minimising any scattering UV light other than that of the measurement zone.

The excitation unit and said detection unit can be mounted in an angle different from 180 degrees, preferably in an angle equal to or smaller than 90 degrees. It is thus guaranteed that no direct LED radiation is able to enter the photo-diode (respectively the cut-off filter).

In a preferred embodiment, the cut-off filter is mounted directly in front of said photodiode, so that it is guaranteed that no scattering light other than through the cut-off filter is entering the photo diode.

In order to be able to scan different regions of a sample, said excitation unit and said detection unit are preferably movable with respect to said sample holder. The position of the excitation unit and the detecting unit can manually adjusted or controlled by an actuator for moving said excitation unit and said detection unit along a sample positioned in said sample holder. The actuator for the scanning movement might be an electrical motor, or preferably by a clockwork type motor running without electricity but with a mechanical spring.

The device for determination of aflotoxins comprises preferably signal-processing unit for processing an electrical signal generated by said photodiode. This signal-processing unit can e.g. comprise an amplification circuit for amplifying said electrical signal generated by said photodiode. The amplified signal can be displayed on a digital multimeter. In a more preferred embodiment the signal-processing unit comprises means for converting said electrical signal generated by said photodiode into a digital signal, which can then be further processed and/or displayed, e.g. on a PC. The signal-processing unit can be arranged inside said shielded housing.

It has to be noted that all electrical wires and connections from the photo diode to the signal-processing unit should be shielded and should be as short as possible.

The above described aflatoxin densitometer is an inexpensive and convenient portable instrument, which occupies a small volume. It can be used in TCL aflatoxin determination in food matrices of interest (including feed). A high precision is achieved by simutaneously minimising all sources of error relating to constancy and of the light source, photo diode and amplifying circuits.

### DETAILED DESCRIPTION WITH RESPECT TO THE FIGURES

The present invention will be more apparent from the following description of a not limiting embodiment with reference to the attached drawings, wherein

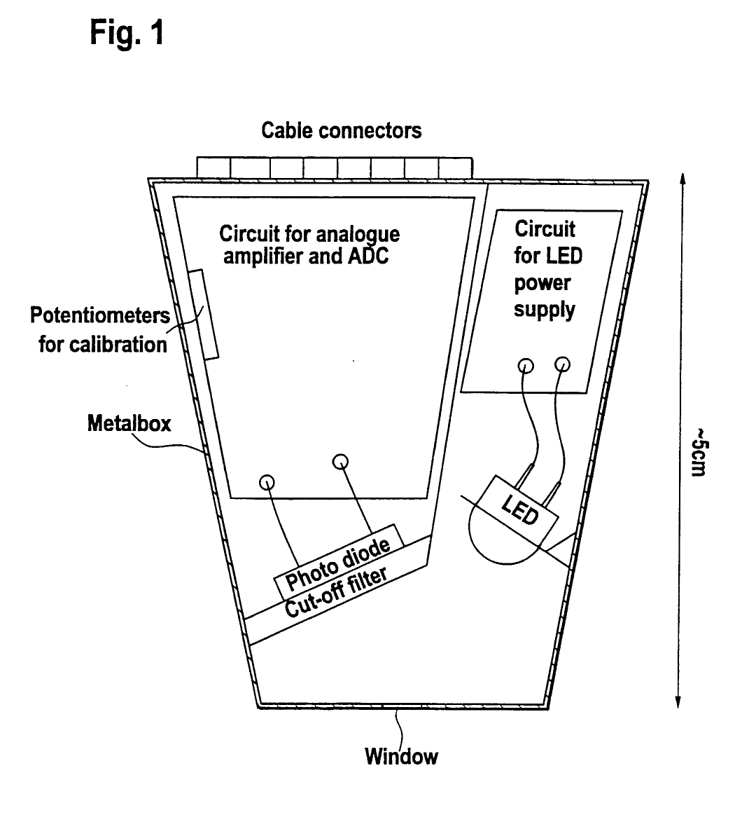

FIG. 1: is a schematic drawing of an embodiment of a detector cell of a device according to the present invention; and

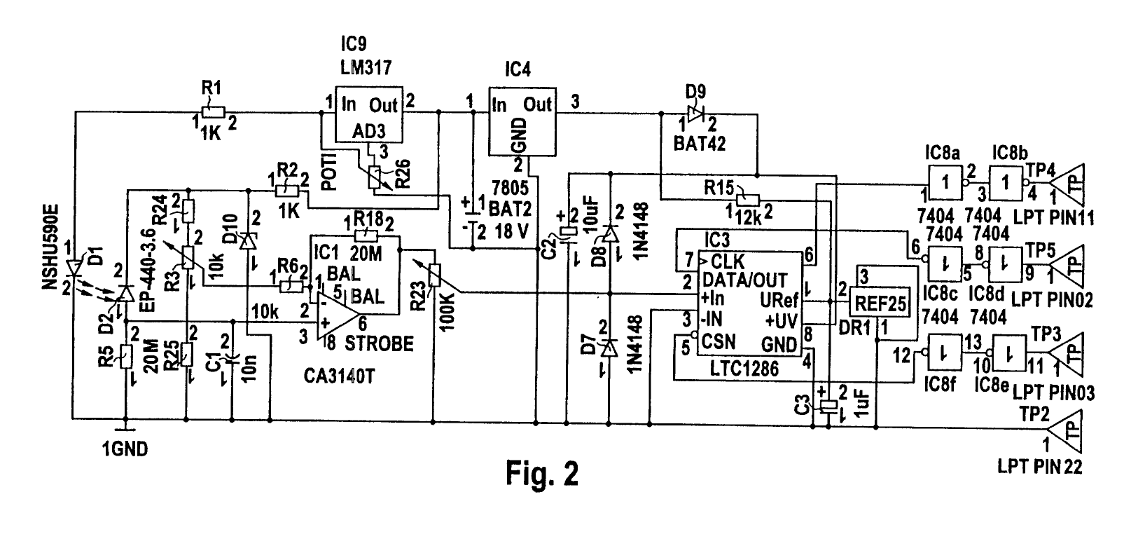

FIG. 2: is a schematic electrical circuit diagram of an instrument in accordance with this invention:

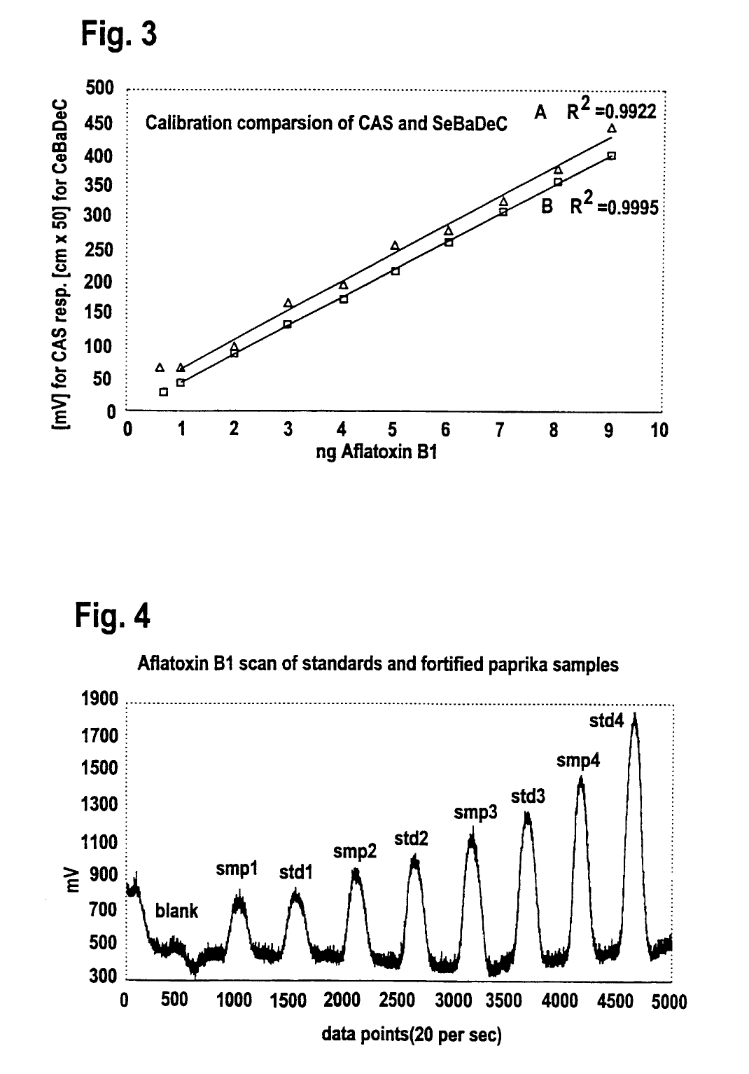

FIG. 3: shows the calibration curves for aflatoxin B1 of a device according to the invention and a commercial available scanner;

FIG. 4: shows a chromatogram of a TLC plate.

A simple, miniaturised and fully semiconductor based detector cell for densitometric measurements of aflatoxins on TLC plates is shown in FIG. 1. A UV-light emitting diode (UV-LED) with a peak emission wavelength of 370 nm is used for fluorescence excitation, while a photo diode with a peak sensitivity of 440 nm in combination with a 418 nm cut-off filter is applied for detecting the fluorescence intensity. The resulting signal can be further amplified by means of a commonly used operational amplifier integrated circuit (OA) and directly converted into a digital signal with a simple analogue-digital-converter (ADC). This signal can then be recorded at the serial (RS232) port of a portable PC and processed with a spreadsheet program.

The low power consumption of around 50 mA (detector cell, OA and ADC) allows the operation by simple means of battery cells. The long lifetime of the UV-LED (up to 10 000 h) permits a maintenance free application of this device.

In order to minimise the influence of external light sources as well as electro-static and magnetic fields, the LED and its power supply, the cut-off filter, the photodiode and the signal processing unit are arranged inside of a discrete metal container. Furthermore the wiring from the photodiode to the amplifier was made with shielded cables. In order to allow a reliable and easy data recording the amplified signal is converted with a simple analogue-digital-converter (ADC)

The circuit layout of signal processing unit is shown in FIG. 2.

The UV-LED Dl (NSHU590E) is powered with a constant current of typically 10 mA via the IC9 (LM317) and R1, thus minimizing any fluctuations of the LED light. The reflected fluorescence light of the analyte (aflatoxins) is captured by the photo diode D2 (EP440-3.6) and amplified by the operational amplifier (OA) IC1 (CA3140T). The adjustment of the zero value (offset) is performed by a series of the resistors (R3, R24 and R25). Resistor R3 is a high precision potentiometer, while the values of R24 and R25 are selected according to the final design of the detector cell (such as slit width, filter position and distance of diodes to the TLC-Plate). The whole differential input of the OA is stabilized with simple means of a zener-diode and the resistor R2. The value of the zener-diode must be below the lowest operation voltage for the power supply (battery), while values of above 10V are desired to achieve a significant amplification. The OA might be fed directly by the power supply (battery). The factor for the amplification of the signal is the quotient of R18/R6 and should be similar to or above 2000. The output of the OA thus reveals a highly amplified signal which, after offset adjustment, is directly dependent on the current that is leaked by D2, thus resulting in a voltage drop on the series of R5 and D2, that is further amplified.

The choice of the OA is done by the input impedance and wide usage of the simply available IC. The typical impedance is 1.5 Tera Ohm resulting in a very low input current of below 15 pA at 15 V, that guarantees a precise measurement which is not influenced by the input current of the OA.

The output signal is then divided by R23 to a voltage suitable for further measurement.

The amplified analogue signal is preferably converted with an analogue digital converter (ADC) (and a data logger) to a digital signal for further processing with a PC. Alternatively the digital signal might be processed with a BASIC-stamp or micro-controller unit connected to a liquid crystal display and a keyboard. The latter version is aimed to be the stand-alone version with no need for an external laptop or notebook.

In the example shown in FIG. 2, the signal is converted by IC3 (LTC1286) as given in the circuit diagram. The IC3 is a 12 bit ADC that allows a resolution of 4096 signal units. The 12-bit resolution is sufficient for the determination of aflatoxins in the range of current regulatory limits for food and feed (1 ppb to 20 ppb) in combination with an appropriate TLC method. The achieved theoretical electronic resolution of more than 0.005 ppb (12 bit) is sufficient, since a resolution of 0.1 ppb is required for practical purposes. The IC3 is protected by a series of diodes D7 and D8 during final calibration of the device. Furthermore the precision of the signal is enhanced by DR1 which is a 2.5 V reference source.

The communication is carried out between the IC3 and any, possibly portable, PC. IC8 (7404) is a CMOS inverter, which, if put in line to two units, results in a buffer to protect the IC3.

IC8 is powered by the same voltage as IC3 (5V).

All solid state components (semiconductor) and passive electronic parts (except those for adjustment such as R3, R26 and R23 and those for protection—IC8 should be on a socket) are preferably printed on one circuti board as SMD devices if available. This minimises the circuit board.

However, the way of signal recording and processing from the detector is not limited to the approach described above. Many kinds of data logging, data storage or processing systems are nowadays widely used in miniaturised devices of daily use (electronic thermometers, mobile phones).

The above-described densitometer has shown to be able to detect aflatoxin amounts of 1 ng, thus offering a sensitive alternative to currently available TLC-scanners. In combination with an adequate TLC method the device for the detection of aflatoxin allows the determination of aflatoxins at European regulatory levels.

### EXAMPLE

The performance of the device for the detection of aflatoxin (DDA) as described above has been tested on test samples of paprika and pistachios. The developed TLC-plates were first scanned with the commercially available Scanner (CAS) as a reference and subsequently scanned with the developed DDA.

Thin-layer chromatograms with aflatoxin B₁. concentrations ranging from 1 ng to 9 ng absolute per spot were developed and reflected contamination levels of about 1 ng/g and above. Aflatoxin B₁ was chosen to be the single analyte to demonstrate the performance, since it is the predominant aflatoxin found in contaminated food products and is also explicitly regulated as a single contaminant.

For comparison aflatoxin chromatograms were first scanned with the CAS and subsequently re-scanned with the DDA. The scan with the DDA was performed in an angle 90° to the development of the TLC-plate in order to allow the simultaneous determination of all aflatoxin B1 spots in one scan. The detector cell was moved freely by hand along a ruler. The signal was recorded at a speed of 20 data-points per second. Despite some fluctuations in the data and a wobbling baseline that was due to the uneven movement of the detector by hand, an amount of 1 ng aflatoxin B₁. resulted in a clear signal. The recorded data was read into Microsoft Excel97® and transferred into diagram. This diagram was printed and the signals were measured in [cm]. Table 1 shows the data in addition to the densitometric results obtained by CAS. Calibration curves are shown in FIG. 3.

TABLE 1
Results from the calibration with aflatoxin B₁ standards

| Aflatoxin B₁ | CAS | DDA |
|---|---|---|
| spotted (ng) | [mV] | [cm] |
| 1 | 44.9 | 1.4 |
| 2 | 92.5 | 2.0 |
| 3 | 136 | 3.4 |
| 4 | 177 | 4.0 |
| 5 | 219 | 5.2 |
| 6 | 265 | 5.7 |
| 7 | 313 | 6.5 |
| 8 | 360 | 7.6 |
| 9 | 402 | 8.9 |
| Correlation (r =) | 0.9998 | 0.9961 |
| LOD [ng] | 0.4 | 1.5 |
| LOQ [ng] | 0.5 | 2.2 |

Signals for the calibration levels are given for the commercially available scanner = CAS [mV] and for the DDA [cm]. The correlation coefficient, LOD and LOQ were calculated from the 95% confidence interval with a method validation software (MVA).

Further calibrations with all four aflatoxins were made after improving the movement of the detector cell over the TLC-plate. This was achieved by a simple threaded bold support that pushed the detector along the plate when the bold was revolved manually. The results of calibration are listed in Table 2. FIG. 4 shows the obtained chromatogram of a scan of standards and fortified paprika samples.

TABLE 2
Calibration parameters of aflatoxins B₁, B₂, G₁ and G₂
derived from the 95% confidence interval of the calibration curve

| Analyte | AfB₁ | AfB₂ | AfG₁ | AfG₂ |
|---|---|---|---|---|
| Correlation (r =) | 0.9983 | 0.9954 | 0.9944 | 0.9504 |
| LOD [ng] | 1.2 | 1.7 | 1.7 | 4.8 |
| LOQ [ng] | 1.9 | 2.8 | 2.5 | 7.1 |
| RSD [%] (method) | 2.8 | 3.8 | 5.0 | 15.7 |

The correlation coefficient, LOD and LOQ were calculated from the 95% confidence interval with a method validation software (MVA). The calibration parameters for the aflatoxins B₁, B₂ and G₁ were satisfactory, while the values for G₂ were unexpected high due to deviations of the obtained signals. However repeated experiments indicated that aflatoxin G₂ calibration data is conceivable lower in the range of the other aflatoxins.

For further characterisation of the detector the long-term drift of the signal was investigated. Therefore the detector cell was positioned over an aflatoxin free spot of the TLC-plate and the signal was recorded for 50 minutes. The drift was found to be 1.8% over the measured time range. This indicates that during a scan time of approximately 3 to 5 minutes no measurable drift should occur.

As aflatoxins are subject to UV-light degradation [16] the radiation during the fluorescence measurement might effect results significantly. Signal fading rates of 50% within 3 min were reported with spotmeters [5] and limited the maximum radiation exposure of spots during measurement to 10 sec. However, the power ratings of the UV-LED are as low as 750 μW at a single small bandwidth of 370 nm. In contrary to this, previously described UV-light sources were based on fluorescent gas tubes or mercury tubes with significantly higher power ratings of several Watt. This led to the assumption that the described fade should be significantly lower for the DDA. For confirmation the detector cell was positioned over an aflatoxin B₁ spot and the signal was recorded over a time range of 45 minutes and additionally for 10 minutes over a blank position. The signal fade was calculated to be less than 1.5 % within a time frame of 1 minute. This time was assumed to be the maximum exposure time during several measurements.

Finally, fortified test samples of paprika powder and pistachios were analysed by TLC and the aflatoxin B₁ content was measured with both densitometers, the DDA and the CAS. As shown in Table 3 the data obtained in this comparison are very similar which confirms that the here proposed DDA is capable to determine aflatoxin spots already with a sufficient precision. However, more effort is foreseen in construction and electronics to achieve results comparable to commercial densitometers.

TABLE 3
Results of the analysis of fortified paprika powder
with aflatoxins B₁ and G₂

| Aflatoxin added | Aflatoxin B₁ found | | Aflatoxin G₂ found | |
|---|---|---|---|---|
| [ng/g] | CAS | DDA | CAS | DDA |
| blank | 0 | 0 | 0 | 0 |
| 1 | 0.9 | 0.9 | 0.9 | 0.9 |
| 2 | 1.5 | 1.6 | 1.5 | 1.7 |
| 3 | 2.8 | 2.5 | 2.7 | 3.0 |
| 4 | 3.3 | 3.0 | 3.0 | 3.3 |

Results were calculated from a 4 point calibration curve with standards that reflect the different contamination level of the fortified material.

1. Device for the detection of aflatoxin, comprising a sample holder, an excitation unit and a detection unit, wherein
said excitation unit comprises an light emitting diode, said light emitting di-ode for emitting an excitation radiation having an excitation wavelength in the ultraviolet spectrum, and
said detection unit comprises a cut-off filter and a photodiode, said cut-off filter having a cut-off wavelength which is higher than said excitation wave-length of said light emitting diode and said photodiode having a sensitivity at a sensing wavelength which is higher than said cut-off wavelength, and
wherein said sample holder, said excitation unit and said detection unit are arranged so that said excitation radiation is emitted towards a sample placed in said sample holder and that said cut-off filter and said photodiode are positioned in the direction of emission of a fluorescence radiation emitted from said sample.

2. Device according to 1, characterised in that said excitation radiation has a peak wavelength of about 370 nm, said cut-off wavelength is about 418 nm and said photodiode has a sensitivity peak at a sensing wavelength of about 440 nm.

3. Device according to any one of claims 1 or 2, characterised in that said excitation unit and said detection unit are arranged in a shielded housing, said shielded housing comprising an window transparent to ultraviolet radiation, and in that said sample holder is arranged so that a sample placed in said sample holder is positioned outside of said shielded housing in front of said window.

4. Device according to claim 3, characterised in that inner walls of said shielded housing comprise a coating for absorbing radiation with a wave-length comparable to said excitation wavelength.

5. Device according to any one of claims 1 to 4, characterised in that said excitation unit and said detection unit are mounted in an angle different from 180 degrees.

6. Device according to claim 5, characterised in that said excitation unit and said detection unit are mounted in an angle equal to or smaller than 90 degrees.

7. Device according to any one of claims 1 to 6, characterised in that said cut-off filter is mounted directly in front of said photodiode.

8. Device according to any one of the preceding claims, characterised in that said excitation unit and said detection unit are movable with respect to said sample holder.

9. Device according to claim 8, characterised by an actuator for moving said excitation unit and said detection unit along a sample positioned in said sample holder.

10. Device according to any one of the preceding claims, characterised by a signal-processing unit for processing an electrical signal generated by said photodiode.

11. Device according to claim 11, characterised in that said signal-processing unit comprises an amplification circuit for amplifying said electrical signal generated by said photodiode.

12. Device according to claims 10 or 11, characterised in that said signal-processing unit comprises means for converting said electrical signal generated by said photodiode into a digital signal.

13. Device according to any one of claims 10 to 12, characterised in that said signal processing unit is arranged inside said shielded housing.
